(19) United States
(12) Patent Application Publication
(10) Pub. No.: US 2008/0101172 A1
(43) Pub. Date: May 1, 2008

(54) Optical disc apparatus

(75) Inventor: Hiroshi Kubota, Fussa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/976,815

(22) Filed: Oct. 29, 2007

(30) Foreign Application Priority Data
Oct. 31, 2006 (JP) 2006-297058

(51) Int. Cl. G11B 7/00

(52) U.S. Cl. 369/44.26

(57) ABSTRACT

According to one embodiment, an optical disc apparatus provides a stable tracking error signal for aligning the center of a track or record mark string with the center of a laser beam irradiated to a recording surface by an object lens, when an object lens is moved along the radial direction of an optical disc, by adding an output corrected to be able to reduce the influence of an offset deviation component obtained by a second processing of an adder, to an offset obtained by a first processing of an adder, when a defect or adhesion of material affecting optical characteristics is detected on a recording medium.

### CROSS-REFERENCE TO RELATED APPLICATIONS

This application is based upon and claims the benefit of priority from Japanese Patent Application No. 2006-297058, filed Oct. 31, 2006, the entire contents of which are incorporated herein by reference.

### BACKGROUND

1. Field

One embodiment of the present invention relates to a signal processing method capable of reducing occurrence of an out-of-track condition caused by a defect or fingerprint on a disc, when reproducing information recorded in an optical disc as a recording medium, or recording information on an optical disc, and an optical disc apparatus using the signal processing method.

2. Description of the Related Art

It has been a long time since practical use of an optical disc apparatus that is an apparatus handling an optical disc capable of reproducing prerecorded information by using a laser beam, or recording information by a laser beam.

As a recording medium (optical disc), the Digital Versatile Disc (DVD) standard optical disc has been widely used.

Among DVD-standard optical discs, in an optical disc other than a play-only ROM type, for example, a write once type disc capable of writing information only once, and a rewritable type disc capable of writing information repeatedly, a recording track (a flat part contrary to a guide groove or a groove) is formed on an information recording surface of a disc.

A recording track is formed to coincide with a center of an optical spot of a laser beam, when recording and reproducing information in/from an optical disc. If the center of an optical spot does not trace the center of a recording track, an out-of-track condition occurs, and information recording/reproducing becomes difficult.

An out-of-track condition is likely to occur, when the recording surface of an optical disc is damaged by accidental drop or scratch (of an optical disc), or when a fingerprint or material that affects optical characteristics is adhered to an optical disc while the user handles a disc.

In the circumstances, it has been reported that a tracking error signal is corrected by assuming a sudden fluctuation of a tracking error signal caused by a defect or fingerprint on a disc.

For example, Japanese Patent Application Publication (KOKAI) No. 11-73656 discloses a method of correcting a tracking error including an offset component always during servo tracking, by a cancel signal obtained by attenuating a high-frequency component by a low-pass filter.

In the Japanese Patent Application Publication (KOKAI) No. 2001-23197 discloses a method of limiting the control of a tracking control means, based on the magnitude of a tracking error signal caused by a defect on an optical recording medium.

Further, in the Japanese Patent Application Publication (KOKAI) No. 2003-168227 discloses a method of driving an objective lens by using a PWM signal matching with a DC level of a preceding servo signal, when a track defect of an optical disc is detected by a defect detector.

However, even any method disclosed in the above documents or by combination of these methods cannot avoid an extreme change in the gain of a tracking error signal, when a track defect exists on an optical disc, or a fingerprint or material that affects optical characteristics adheres to an optical disc. An offset component is usually superposed on a tracking error signal, and an out-of-track condition may occur when eliminating the influence of the above track defect or adhesion of undesired material by simple filtering.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus according to an embodiment of the invention;

FIG. 2 is an exemplary diagram showing an example of a tracking error signal generator of a signal processing circuit of the optical disc apparatus shown in FIG. 1, according to embodiment of the invention; and

FIG. 3 is an exemplary flowchart showing examples of a tracking error signal generator of a signal processing circuit of the optical disc apparatus shown in FIG. 1, according to an embodiment of the invention.

### DETAILED DESCRIPTION

Various embodiments according to the invention will be described hereinafter with reference to the accompanying drawings. In general, according to one embodiment of the invention, an optical disc apparatus provides a stable tracking error signal for aligning the center of a track or record mark string with the center of a laser beam irradiated to a recording surface by an object lens, when an object lens is moved along the radial direction of an optical disc, by adding an output corrected to be able to reduce the influence of an offset deviation component obtained by a second processing of an adder, to an offset obtained by a first processing of an adder, when a defect or adhesion of material affecting optical characteristics is detected on a recording medium.

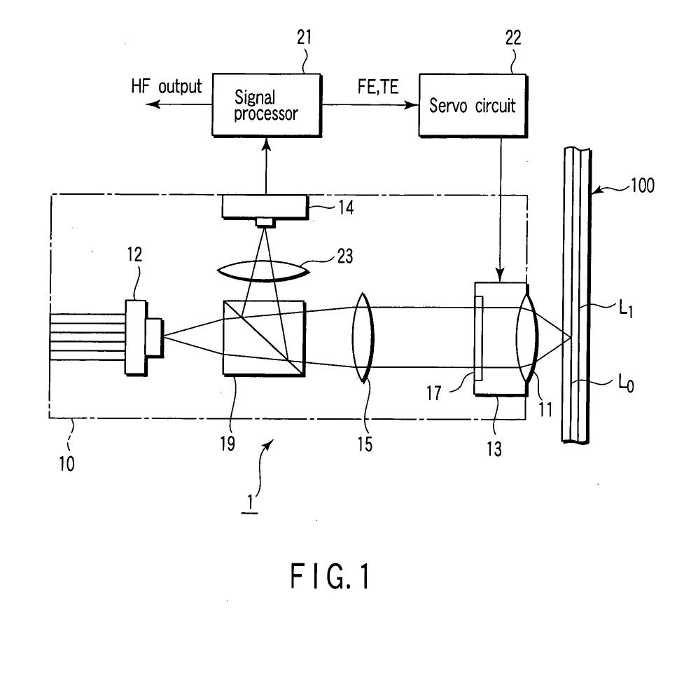

FIG. 1 shows the configuration of an information recording-reproducing apparatus (optical disc apparatus) according to an embodiment of the invention.

The optical disc apparatus 1 shown in FIG. 1 includes an optical pickup unit (optical head unit) 10, which can record information on an recording layer not described in detail of a recording medium (optical disc) 100, for example, an organic film, metallic film or phase-change film, read information recorded on the recording layer, or erase information recorded in the recording layer. Though not described in detail, in addition to the optical head unit 10, the optical disc apparatus 1 includes mechanical elements, such as, a head moving mechanism to move the optical head unit 10 along the recording surface of an optical disc D, and a not-shown disc motor to rotate an optical disc 100 at a predetermined speed. As explained later, the optical disc apparatus 1 includes a signal processor to process the output of a photodetector incorporated in the optical head unit 10, and a control unit to control the mechanical elements of the optical head unit 10.

The optical head unit 10 is arranged close to the optical disc 100, and includes an objective lens 11, which condenses a laser beam from a light source, for example, a laser diode (LD) 12 that is a semiconductor laser element on an optical recording layer L0, L1 of the optical disc 100, and captures a laser beam reflected from a recording layer of the optical disc 100. A wavelength of a laser beam output from the laser diode 12 is 400-410 nm, preferably 405 nm. The laser diode 12 and objective lens 11 are held by an actuator 13.

A laser beam from the laser diode 12 passes through a polarized beam splitter (PBS) 19 provided at a predetermined position, collimated (made parallel) by a collimator lens (CL), and guided to objective lens (OL) 11, passing through a diffraction element 17 consisting of an optical dividing element, or a hologram plate (hologram optical element [HOE]) formed as one body with a λ/4 plate (¼-wavelength plate, or polarization control element). The objective lens 11 and diffraction element 17 are held as one body by a lens holder 13.

The laser beam guided to the objective lens 11 is given a predetermined convergence, and condensed on one of the recording layers L0 and L1 of the optical disc 100. On the recording layers L0 and L1 of the optical disc 100, a guide groove or a recording track, or a record mark (recorded data) line is formed concentrically or spirally with a pitch of 0.34 to 1.6 μm. The numerical aperture (NA) of the objective lens 11 is 0.65, for example.

The laser beam given a predetermined convergence by the objective lens 11 passes through a cover layer not described in detail of an optical disc, and condensed on any one of recording layers (or an area nearby) (the laser beam from LD 12 forms a minimum optical spot at the focal position of the objective lens 11).

The objective lens 11 (optical head unit 10) is positioned at a predetermined position in the direction of track crossing a track (a record mark string) of each recording layer of the optical disc 100, and at a predetermined position in the direction of focus that is the thickness direction of the recording layer, by a not-shown objective lens driving mechanism including a driving coil and a magnet, for example. Controlling the position of the object lens 11 for coinciding a minimum optical spot of a laser beam with the center of track (record mark string) by moving the objective lens 11 toward the track, is called a tracking control. Controlling the position of the objective lens for coinciding the distance from the recording layer to the objective lens 11, with the focal distance of the objective lens 11, by moving the objective lens 11 toward the focus, is called a focus control.

The reflected laser beam reflected on the recording layer L0 or L1 of the optical disc 100 is captured by the objective lens, converted to a beam with a substantially parallel cross section, and returned to the diffraction element 17.

As the diffraction element 17 serves also as a λ/4 plate, the reflected laser beam, which is returned to the diffraction element 17, passed through the diffraction element 17, and returned to the polarized beam splitter 19, is reflected on a plane of the polarized beam splitter 19 (not described in detail) is rotated by 90°, since the direction of polarized plane of the laser beam directed to the recording layer of the optical disc 100.

The reflected laser beam reflected by the polarized beam splitter 19 is given astigmatic aberration by a cylindrical lens 23 having power inclined by 45° with respect to the tangential or radial direction, and given a predetermined convergence by the collimator lens 15, and forms an image on a light-receiving plane of a photodetector (PD) 14. In this time, when passing through the diffraction element 17, the reflected laser beam is diffracted to a predetermined number of divisions and shape, according to the arrangement and shape of a detection area (light-receiving area) previously given on the light-receiving plane of the photodetector 14.

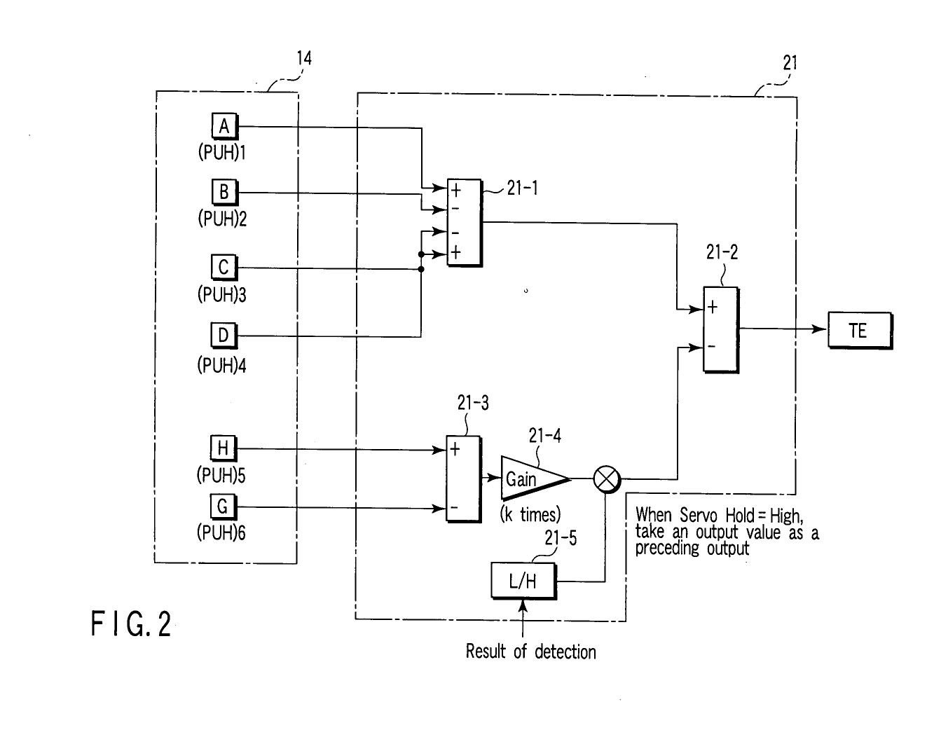

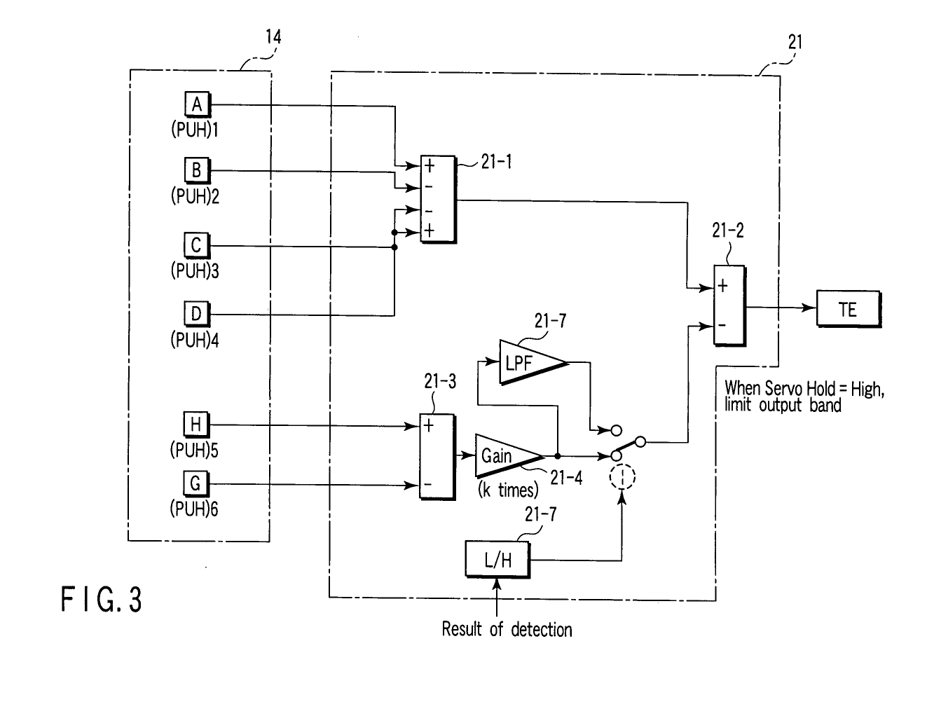

A current output from each light-receiving portion of the photodetector 14 (to be explained in detail with reference to FIG. 2 or FIG. 3) is converted to a voltage by a not-shown I/V amplifier, and applied to a signal processor 21, which processes the input voltage to be used as an HF (reproducing) output, a tracking error signal TE and a focus error signal FE. The HF (reproducing) output is converted to a predetermined signal format not described in detail, or output to a temporary storage unit or an external storage unit through a predetermined interface.

A signal obtained from the signal processing circuit 21 is used also as a servo signal for moving the position of the objective lens 11 of the optical head unit 10 in the direction (optical axis direction) orthogonal to the plane including the recording surface of the optical disc 100 and in the direction orthogonal to the direction of extending the track or record mark (line) previously formed on the recording surface of the optical disc, so that the distance from the objective lens 11 to the recording layer L0 or L1 of the recording surface of the optical disc 100 coincides with the focal distance of the objective lens 11.

The servo signal is formed based on the focus error signal indicating a change in the position of the objective lens 11, so that an optical spot of a predetermined size at the focal position of the objective lens 11 becomes to be that predetermined size on the recording layer L0 or L1 of the optical disc 100, according to a known focus error detection method, and the tracking error signal indicating a change in the position of the objective lens 11, so that the optical spot is guided along substantially the center of the record mark string or track, according to a known tracking error detection method.

Namely, the objective lens 11 is controlled, so that the optical spot condensed by the objective lens 11 can be provided as a minimum optical spot on the recording layer at its focal distance at substantially the center of the track or record mark string formed on each recording layer L0 and L1.

FIG. 2 shows the photodetector 14, signal processing circuit 21 and servo circuit 22, each incorporated in the optical head unit 10 of the optical disc apparatus shown in FIG. 1, explaining the method and configuration of generating the tracking error signal TE according to the invention.

In FIG. 2, the photodetector 14 includes four detection areas A ((PUH)1) to D ((PUH)4) for obtaining a HF signal, a focus error signal FR and a tracking error signal MPP (TE), and two detection areas H ((PUH)5) and G ((PUH)6) for obtaining a tracking error signal SPP (TE). In FIG. 2, the portion concerning the tracking error signal is particularly explained in detail.

The outputs from detection areas A to D of the photodetector 14 are applied to an adder 21-1, which adds the outputs in a predetermined combination to provide a known push-pull signal (MPP, a DC offset component indicating a track offset for shifting the objective lens 11), and input to an adder 21-2. Similarly, the outputs from detection areas H and G of the photodetector 14 are added by an adder 21-3 to obtain a known push-pull signal (SPP, a signal proportional to a lens shift (a signal for correcting the defect of MPP), mainly used for eliminating the influence of a rotation cycle (frequency component) of an optical disc), and input to the adder 21-2. Though not described in detail, the detection areas H and G are arranged in positions where the shade of a reflected laser beam reflected from the track or record mark string is projected in one of the areas of or at the center of both of the optical disc 100. Namely, the detection areas H and G are arranged with respect to the direction of extending the track previously formed in the optical disc 100, or in the direction of extending the record mark string defined by the recorded information, to be capable of detecting a displacement from the center.

The SPP (the output of the adder 21-3) is used to correct the control amount for the lens shift to incline the object lens 11 according to the rotation of the optical disc (rotation cycle), in order to sequentially condense the laser beam given a predetermined convergence by the objective lens 11 at the center of different adjacent tracks, in the state that the position of the objective lens 11 in the disc radial direction is fixed. The SPP is supplied to the adder 21-2 after the gain is set through a gain controller 21-4. In this time, under the specific condition explained below, the SPP is replaced by the output that is held by a servo hold circuit 21-5.

When the MPP and SPP are added by the adder 21-2, the gain of SPP that is the output of the adder 21-3 is amplified to a predetermined magnitude (k times) by the gain controller 21-4.

However, if the SPP is lacked by a defect of a disc (damage similar to a track) or adhesion of material affecting optical characteristics (fingerprint or viscous and solid materials affecting refractive index), the SPP amplified by the gain controller 21-4 becomes prevalent in the output of the adder 21-2, and the magnitude of the tracking error signal TE (the output of the adder 21-2) is suddenly changed, causing an out-of-track condition in many cases. It is possible to eliminate the influence of a defect of a disc or adhesion of material by utilizing the fact that the lack or sudden change of the SPP caused by the disc defect or adhered material is extremely higher than the frequency component (optical disc rotation cycle) included in the SPP.

Therefore, the tracking error signal TE can be stably held by holding (holding the preceding output value) the output of the gain controller 21-4, when a defect or adhered material of a disc is detected. As a method of detecting a defect and adhered material of a disc, any one of currently used methods can be used, and two or more methods can be combined.

FIG. 3 shows another embodiment for obtaining the tracking error signal shown in FIG. 2. The same reference numerals are given to the elements same as or similar to those explained in FIG. 2, and detailed explanation of these elements will be omitted.

In FIG. 3, the output from detection areas A to D of the photodetector 14 are applied to the adder 21-1, which adds the outputs in a predetermined combination to provide a known push-pull signal (MPP), and input to an adder 21-2. Similarly, the outputs from detection areas H and G of the photodetector 14 are added by an adder 21-3 to obtain a known push-pull signal (SPP), and input to the adder 21-2.

When the MPP and SPP are added by the adder 21-2, the gain of SPP that is the output of the adder 21-3 is amplified to a predetermined magnitude (k times) by the gain controller 21-4. Between the gain controller 21-4 and adder 21-2, a switch 21-6 is provided, and a low-pass filter 21-7 can be inserted for the output from the gain controller 21-4 in the specific condition explained below.

In the tracking error signal generation circuit shown in FIG. 3, if the SPP is lacked by a defect of a disc (damage similar to a track) or adhesion of material affecting optical characteristics (fingerprint or viscous and solid materials affecting refractive index), only the SPP amplified by the gain controller 21-4 remains, and the magnitude of the tracking error signal TE (the output of the adder 21-2) is suddenly changed, causing an out-of-track condition in many cases. It is possible to eliminate the influence of disc defects or adhered materials by utilizing the fact that the lack or sudden change of the SPP caused by the disc defect or adhered material is extremely higher than the frequency component (optical disc rotation cycle) included in the SPP. Therefore, when a defect or adhered material of a disc is detected, a stable tracking error signal can be obtained by eliminating a high-frequency component of the output of the gain controller 21-4 generated by a defect of a disc or adhesion of material affecting optical characteristics, by the low-pass filter 21-7. Limitation of band (cutoff frequency) by the low-pass filter 21-7 may be of course higher than the rotation frequency defined according to the optical disc rpm (rotation cycle).

In mentioned above, the Japanese Patent Application Publication (KOKAI) No. 11-73656 discloses a method of usually a low-pass filter at all times. However, using a low-pass filter at all times induces a change in the track servo characteristic itself (a factor to cause an out-of-track condition), as explained hereinbefore. Therefore, it is essential to use a low-pass filter only in a predetermined condition that the signal-to-noise ratio of a tracking error signal is degraded, as in the present invention.

As explained hereinbefore, according to the invention, it is possible to provide a stable tracking error signal with a simple configuration, by detecting a defect or adhesion of material affecting optical characteristics, and holding the SPP output at a preceding vale only at that time.

Further, by using a low-pass filter (LPF) only when detecting a defect or adhesion of material affecting optical characteristics, it is possible to reduce the influence upon a tracking error signal to a minimum. In this case, the LPF may be designed by considering only the influence of a defect (adhesion of undesired material), and the signal processing channel performance is improved. Namely, a compensation capacity is increased for an extremely large factor compared with a track with a fingerprint or adhesion of undesired material.

When there is a factor extremely larger than a track with a fingerprint, it may be supposed that the possibility of an out-of-track condition cannot be eliminated. However, MPP is valid, and a track servo is effective for an offset, and the frequency of occurrence of an out-of-track condition is largely decreased.

As explained above, according to an embodiment of the invention, it is possible to obtain a signal that is decreased in the influence of a defect or adhesion of material affecting optical characteristics that may occur in a recording medium, upon a tracking error signal including a lens shift component, and can reduce the parts and apparatus costs. Further, normal control is executed when there is no defect or adhesion of material affecting optical characteristics that may occur in a recording medium, the frequency of an occurrence of an out-of-track condition is not increased, as a result of signal processing.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a lens which irradiates light from a light source to a recording surface of a recording medium in a predetermined spot size, and captures a reflected light reflected from the recording surface;
a support unit which supports the lens movably along a radial direction of a recording medium, so that the distance to a recording surface of a recording medium coincides with a focal distance of the lens;
a photodetector which detects a reflected light captured by the lens, and outputs a predetermined output signal; and
an error signal processing element which gains a control amount to coincide the center a track peculiar to a recording surface of a recording medium or a record mark string formed on a recording surface with the center of the light irradiated from the lens to the recording surface, when moving the support unit along the radial direction of a recording medium, and gains a signal decreased in the influence of a defect or adhesion of material affecting optical characteristics that may occur in a recording medium, upon an offset obtained by a first processing, by using an offset correction component obtained by a second processing, when obtaining an error signal by adding the offset obtained by the first processing to the offset correction component obtained by the second processing, among the outputs of the photodetector.

2. The optical disc apparatus according to claim 1, wherein
the photodetector includes first and second detection areas to detect a degree of moving a component corresponding to the track or record mark string in the radial direction of the recording surface, and the error signal processing element gains an error signal by adding an output substituted for the offset correction component obtained from the output of the second detection area by the second processing, to the offset obtained from the output of the first detection area by the first processing, as an output value fixed (held) immediately before detection of a defect or adhesion of material affecting optical characteristics, when the defect or adhesion of material affecting the optical characteristic is detected on the recording surface of the recording medium.

3. The optical disk apparatus according to claim 1, wherein
the error signal processing element gains an error signal by adding an output substituted for the output limiting the frequency component band of the offset obtained by performing the second processing for the output from the second detection area, to the offset obtained by performing the first processing for the output from the first detection area, when the defect or adhesion of material affecting the optical characteristic is detected on the recording surface of the recording medium.

4. The optical disc apparatus according to claim 3, wherein
in the error processing element, the limitation of the frequency band to the frequency component of the offset correction component obtained by the second processing is a frequency higher than a rotation frequency defined corresponding to a recording medium rotation cycle, and lower than a frequency of a defect.

5. A method of detecting irradiation of an optical spot at the center of a track or record mark string for irradiating light given convergence at the center of a track previously prepared on a recording medium or a record mark string with data recorded, comprising:
performing a first processing for an output of a first photodetector for detecting irradiation of an optical spot at the center of a track or record mark string, by a first signal processing circuit;
performing a second processing for an output of a second photodetector for detecting a component fluctuated by the influence of eccentricity occurred during rotation of a recording medium included in an output of a first photodetector, by a second signal processing circuit; and
fixing the magnitude of a signal output from a second signal processing circuit to the magnitude of a signal output immediately before, when a defect or adhesion of material affecting optical characteristics is detected on a recording medium.

6. A method of detecting irradiation of an optical spot at the center of a track or record mark string for irradiating light given convergence at the center of a track previously prepared on a recording medium or a record mark string with data recorded, comprising:
performing a first processing for an output of a first photodetector for detecting irradiation of an optical spot at the center of a track or record mark string, by a first signal processing circuit;
performing a second processing for an output of a second photodetector for detecting a component fluctuated by the influence of eccentricity occurred during rotation of a recording medium included in an output of a first photodetector, by a second signal processing circuit; and
limiting a band of a frequency component obtained by performing the second processing for a signal output from the second signal processing circuit, to a low-frequency side, when a defect or adhesion of material affecting optical characteristics is detected on a recording medium.
